(19) United States
(12) Patent Application Publication
(10) Pub. No.: US 2014/0067581 A1
(43) Pub. Date: Mar. 6, 2014

(54) ELECTRONIC COMMERCIAL TRANSACTION DEVICE

(71) Applicant: Hisanori Yamahara, Shinagawa-ku (JP)

(72) Inventor: Hisanori Yamahara, Shinagawa-ku (JP)

(73) Assignee: RAKUTEN, INC., Shinagawa-ku, Tokyo (JP)

(21) Appl. No.: 14/114,270

(22) PCT Filed: Apr. 9, 2012
(86) PCT No.: PCT/JP2012/059713

§ 371 Date: Oct. 28, 2013

(30) Foreign Application Priority Data
Jun. 30, 2011 (JP) 2011-145889

(51) Int. Cl. G06Q 30/06

(52) U.S. Cl. CPC G06Q 30/0601
USPC 705/26.1

(57) ABSTRACT

An EC server (10) stores time when a user has accessed item information indicating an item sold with a first selling condition as a reference time into an access history database (24). The EC server (10) includes a price adjustment unit (12b) that, when the user accesses the item information after the reference time, sets a second selling condition being less favorable to the user than the first selling condition based on an elapsed time period from the reference time to the access or the number of accesses to the item information by the user after the reference time, and a page transmitting unit (13) that presents the second selling condition in place of the first selling condition to the user.

### TECHNICAL FIELD

One embodiment of the present invention relates to an electronic commerce device, an electronic commerce method, an electronic commerce program, and a computer-readable recording medium storing the program.

### BACKGROUND ART

In electronic commerce, a variety of schemes to encourage more active transactions have been used. For example, a management system for increasing the number of sales of goods that are on the market through information communication means in consideration of the tendency of consumers to delay purchases as they wait for a lower price is disclosed in Patent Literature 1 below. In this management system, the price of an item increases continuously or discontinuously up to a certain amount (terminal price) from the start of sales of the item with the lapse of time or with an increase of the number of advance sales in a uniform manner for each item, and the price paid by a user for the purchase of an item is determined by price information and timing when a purchase request is received.

### CITATION LIST

### Patent Literature

PTL 1: JP 2002-7829 A

### SUMMARY OF INVENTION

### Technical Problem

However, because there are only few users who are aware of the presence of an item from the beginning of sales of the item, most users can purchase the item only under the condition after a price change has occurred (terminal condition). Thus, after all, the price of an item seems to be fixed for most users, and therefore it does not effectively promote the purchase of the item.

In view of the foregoing, an object of one aspect of the present invention is to solve the above problem and effectively promote the purchase of items in electronic commerce.

### Solution to Problem

An electronic commerce device according to one aspect of the present invention includes a recording unit configured to record time when a user has accessed item information indicating an item sold with a first selling condition as a reference time into a storage unit, an adjustment unit configured to, when the user accesses the item information after the reference time, set a second selling condition being less favorable to the user than the first selling condition based on an elapsed time period from the reference time to the access or the number of accesses to the item information by the user after the reference time, and a presentation unit configured to present the second selling condition in place of the first selling condition to the user.

An electronic commerce method according to one aspect of the present invention is an electronic commerce method executed by an electronic commerce device, the method including a recording step of recording time when a user has accessed item information indicating an item sold with a first selling condition as a reference time into a storage unit, an adjustment step of, when the user accesses the item information after the reference time, setting a second selling condition being less favorable to the user than the first selling condition based on an elapsed time period from the reference time to the access or the number of accesses to the item information by the user after the reference time, and a presentation step of presenting the second selling condition in place of the first selling condition to the user.

An electronic commerce program according to one aspect of the present invention causes a computer to implement a recording unit configured to record time when a user has accessed item information indicating an item sold with a first selling condition as a reference time into a storage unit, an adjustment unit configured to, when the user accesses the item information after the reference time, set a second selling condition being less favorable to the user than the first selling condition based on an elapsed time period from the reference time to the access or the number of accesses to the item information by the user after the reference time, and a presentation unit configured to present the second selling condition in place of the first selling condition to the user.

A computer-readable recording medium according to one aspect of the present invention stores an electronic commerce program causing a computer to implement a recording unit configured to record time when a user has accessed item information indicating an item sold with a first selling condition as a reference time into a storage unit, an adjustment unit configured to, when the user accesses the item information after the reference time, set a second selling condition being less favorable to the user than the first selling condition based on an elapsed time period from the reference time to the access or the number of accesses to the item information by the user after the reference time, and a presentation unit configured to present the second selling condition in place of the first selling condition to the user.

According to the above aspects, the selling condition for an item is adjusted to be less favorable to a user based on the elapsed time or the number of accesses after the reference time when the user has accessed item information. Then, in place of the first selling condition before adjustment, the second selling condition after adjustment is presented to the user. Accordingly, as the decision of purchase is earlier, the purchase condition applied to the user is more favorable, and therefore early purchase is encouraged to each user. As a result, it is possible to promote the purchase of an item in electronic commerce more effectively.

In the electronic commerce device according to another aspect, the recording unit may further record access activity to the item information by the user after the reference time into the storage unit, and the adjustment unit may set the second selling condition based further on the access activity. By adjusting the selling condition in consideration of the user's access activity to the item information after the reference time as well, it is possible to effectively encourage early purchase to the user.

In the electronic commerce device according to another aspect, the selling condition may be represented by a numerical value, and the adjustment unit may set the second selling condition depending on elapsed time from the reference time using a rate of change of the selling condition per unit time. It is thereby possible to adjust the selling condition so that the selling condition becomes less favorable to the user little by little each unit time.

In the electronic commerce device according to another aspect, when the item is selected as a candidate to be purchased by the user, the adjustment unit may set a first rate of change during a specified period from when the item is selected as a candidate to be purchased to be lower than a second rate of change during a period other than the specified period. Because changing the selling condition of the item selected as a candidate to be purchased can inhibit the purchase, by reducing the rate of change of the selling condition of the item, it is possible to prompt the user to purchase the item.

In the electronic commerce device according to another aspect, the adjustment unit may refer to a purchase database configured to store purchase information indicating that a purchaser has purchased an item and calculate the number of sales of the item during a specified period, and increase the rate of change in accordance with an increase in the number of sales. Because an item with a large number of sales is more likely to be purchased by a user, by setting the rate of change in consideration of the number of sales, it is possible to encourage the purchase of such an item.

In the electronic commerce device according to another aspect, the adjustment unit may refer to an evaluation database configured to store evaluation information indicating an evaluation score assigned to a purchased item by a purchaser and calculate statistics of evaluation scores of the item, and increase the rate of change in accordance with an increase in the statistics. Because an item with a high evaluation score is more likely to be purchased by a user, by setting the rate of change in consideration of the evaluation score, it is possible to encourage the purchase of such an item.

In the electronic commerce device according to another aspect, the adjustment unit may acquire terminal information indicating a type of a terminal of the user from the terminal, determine the number of web pages that can be displayed at the same time on the terminal based on the terminal information, and reduce the rate of change in accordance with an increase in the number of web pages that can be displayed at the same time. Because there is sometimes a tendency that a user promptly decides the purchase in the environment where it is difficult to view a plurality of sites at the same time, by setting the rate of change in this manner, it is possible to encourage such a tendency.

In the electronic commerce device according to another aspect, the adjustment unit may refer to a viewing database configured to store viewing information indicating that item information has been presented to a viewer and a purchase database configured to store purchase information indicating that a purchaser has purchased an item and calculate statistics of time for the user to purchase an item indicated by the item information after the item information is presented to the user, and reduce the rate of change in accordance with an increase in the statistics. By setting a higher rate of change for a user who is likely to make impulse buying, it is possible to encourage such a tendency.

In the electronic commerce device according to another aspect, the adjustment unit may set the first selling condition to a favorable condition to the user in accordance with an increase in the rate of change applied to the user. By setting the first selling condition to a more favorable value to the user and increasing the rage of change of the selling condition, it is possible to effectively encourage early purchase to the user.

In the electronic commerce device according to another aspect, the adjustment unit may set the second selling condition within a range from the first selling condition to a terminal condition being a final selling condition for the item applied to the user, and when the terminal condition for the item is less favorable to the user than the current selling condition for another item being the same as or similar to the item and selected as a candidate to be purchased by the user, the adjustment unit may set the terminal condition to be the same as the current selling condition for the another item. In this manner, by changing the selling condition on the item in consideration of another item, it is possible to prompt the user to purchase the item.

In the electronic commerce device according to another aspect, the adjustment unit may refer to an item database configured to store item information indicating the quantity of stock of items and acquire the quantity of stock of the item, and reduce the rate of change in accordance with a decrease in the quantity of stock. Because promoting the purchase of an item with a small quantity of stock causes out-of-stock, it is effective to set the rate of change in order to avoid out-of-stock.

In the electronic commerce device according to another aspect, the adjustment unit may refer to a viewing database configured to store viewing information indicating that item information has been presented to a viewer and calculate the number of users who are provided with adjustment of the selling condition for the item, and reduce the rate of change in accordance with an increase in the number of users. Because promoting the purchase of an item to which a certain number or more of users are accessing causes out-of-stock, it is effective to lower the rate of change in order to avoid out-of-stock.

In the electronic commerce device according to another aspect, when the second selling condition is set based on the number of accesses, the adjustment unit may set the second selling condition corresponding to n-th access in accordance with a time interval from an end of m-th access to a start of the n-th access after the reference time, where m<n. By adjusting the selling condition in consideration of the time interval, it is possible to effectively encourage early purchase to the user.

In the electronic commerce device according to another aspect, the adjustment unit may obtain the second selling condition for when the user accesses the item information next time as next condition, and the presentation unit may present the next condition to the user. In this manner, by letting a user know in advance the future selling condition that is less favorable than the current condition, it is possible to prompt the user to purchase the item.

In the electronic commerce device according to another aspect, the first and second selling conditions may be represented by a price of the item, and the price corresponding to the second selling condition may be higher than the price corresponding to the first selling condition. Advantageous Effects of Invention

According to one aspect of the invention, the selling condition of an item varies from user to user, and thus each user can purchase the item with more favorable conditions as the user makes a decision earlier. It is thereby possible to effectively promote the purchase of items in electronic commerce.

### BRIEF DESCRIPTION OF DRAWINGS

FIG. 1 is a diagram showing an overall configuration of an electronic commerce system (EC system) according to an embodiment.

FIG. 2 is a diagram showing a hardware configuration of an EC server shown in FIG. 1.

FIG. 3 is a diagram showing an example of an access history.

FIG. 4 is a diagram showing an example of discount rate information.

FIG. 5 is a block diagram showing a functional configuration of the EC server shown in FIG. 1.

FIG. 6 is a diagram showing an example of adjustment of a discount rate and a price depending on the lapse of time.

FIG. 7 is a diagram showing an example of adjustment of a discount rate and a price depending on the number of accesses.

FIG. 8 is a diagram showing an example of display of a discount rate and a price adjusted depending on the lapse of time.

FIG. 9 is a diagram showing an example of display of a discount rate and a price adjusted depending on the number of accesses.

FIG. 10 is a sequence chart showing an operation of the EC system shown in FIG. 1.

FIG. 11 is a sequence chart showing an operation of the EC system shown in FIG. 1.

FIG. 12 is a diagram showing a configuration of an electronic commerce program according to an embodiment.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

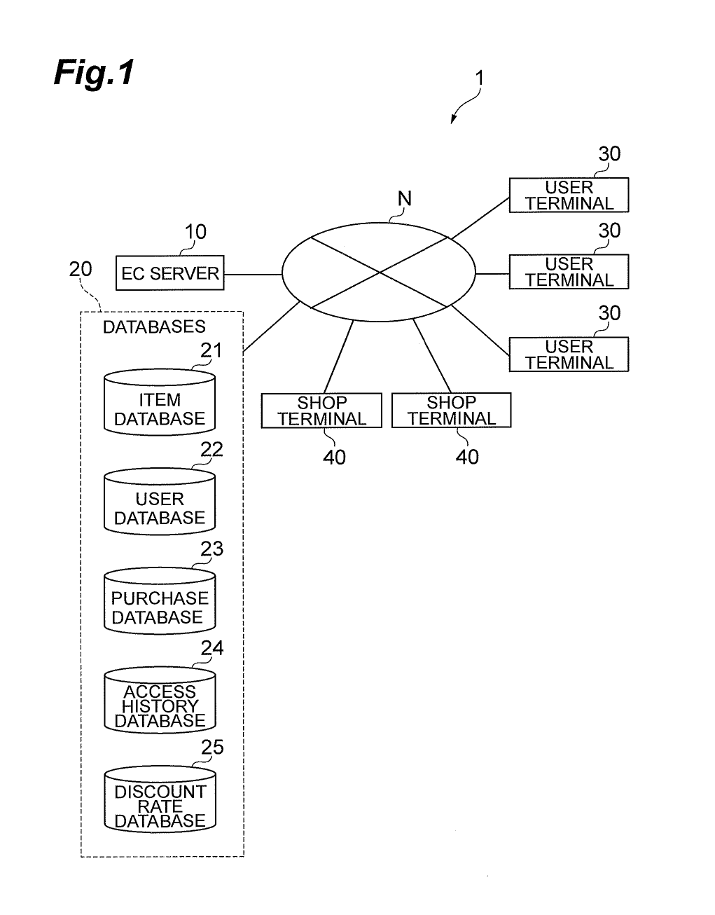

First, the functions and configuration of an electronic commerce system 1 (which is referred to hereinafter as “EC system”) according to an embodiment are described with reference to FIGS. 1 to 9. The EC system 1 is a computer system that provides a web site (EC site) featuring a virtual shopping mall which contains a plurality of virtual shops (which are referred to hereinafter simply as “shops”) to users. As shown in FIG. 1, the EC system 1 includes an EC server (electronic commerce device) 10, databases 20 including various types of databases required for processing related to the EC site, one or more user terminals 30, and one or more shop terminals 40. The EC server 10 can communicate with the databases 20, the user terminals 30 and the shop terminals 40 through a communication network N which is the Internet, a leased line or the like.

With the EC system 1, a user can do the procedure of viewing information of items of shops or purchasing an item. In this embodiment, it is assumed that a user is a member of the EC site and has a user ID for identifying the user which is given by the EC system 1, and views item information and performs an item purchase procedure by logging in the EC site. In the EC system 1, the discount rate of one item in one shop varies from user to user. Hereinafter, a specific item of a specific shop for one user, which is an item for which the discount rate is to be adjusted, is also referred to as “target item”. Specifically, from a reference time when information of a target item is presented to a user for the first time, the discount rate of the item for the user which is presented to the user decreases as time elapses. Conversely, each user can purchase the item with more favorable conditions as the user makes a decision to purchase the item earlier. Such a change in the discount rate is presented to the user. To adjust the discount rate, the EC system 1 monitors access activity to the item information of the target item after the reference time.

Note that, although a user's access activity is monitored based on the user ID of the user who has logged in in this embodiment, it is possible to determine the identity of a user by using HTTP Cookie, ID address and the like when the user is not logging in. However, in the case of this alternative example, the identity of a user cannot be verified when the cookie is deleted or the terminal is changed. Therefore, it is preferred to use the system that monitors a user's access activity based on the user ID of the user who has logged in.

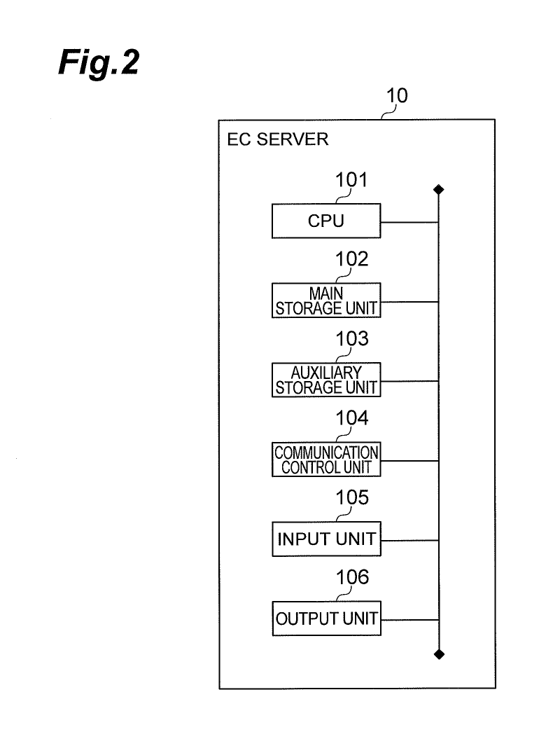

The EC server 10 is a computer that provides an EC site to a user. As shown in FIG. 2, the EC server 10 includes a CPU 101 that executes an operating system, an application program and the like, a main storage unit 102 such as ROM and RAM, an auxiliary storage unit 103 such as a hard disk, a communication control unit 104 such as a network card, an input unit 105 such as a keyboard and a mouse, and an output unit 106 such as a monitor. The functional components of the EC server 10 described later are implemented by loading given software onto the CPU 101 or the main storage unit 102, making the communication control unit 104, the input unit 105, the output unit 106 and the like operate under control of the CPU 101, and performing reading and writing of data in the main storage unit 102 or the auxiliary storage unit 103. The data and database required for processing are stored in the main storage unit 102 or the auxiliary storage unit 103. Note that, although the EC server 10 is composed of one computer in FIG. 2, the functions of the EC server 10 may be distributed among a plurality of computers.

The EC server 10 accesses an item database 21, a user database 22, a purchase database 23, an access history database 24, and a discount rate database 25 according to need. Before describing the functions of the EC server 10, those databases are described hereinbelow.

The item database 21 is a means of storing item information. The item information is registered or updated by processing in the shop terminal 40 or a request processing unit 12, which is described later. The item information is a record where a shop ID for identifying a shop, an item ID for identifying one item in one shop, and the attribute of the item are associated with one another. Examples of the item attribute include an item name, a category, a manufacturer name, a price, an item image, the quantity of stock and the like, though the item attribute may be determined arbitrarily. Note that the item may be a tangible object or a non-tangible object such as offer of a service.

The user database 22 is a means of storing user information. The user information is registered when a user becomes a member of the EC site. The user information is a record where a user ID for identifying a user and the attribute of the user are associated with each other. Examples of the user attribute include a user's name, gender and age, accumulated points earned by purchasing items and the like, though the user attribute may be determined arbitrarily.

The purchase database 23 is a means of storing purchase information indicating that a user has purchased an item. The purchase information is registered when a user purchases an item through the EC site. The purchase information contains a user ID for identifying a user, an item ID for identifying a purchased item, a shop ID for identifying a shop that sold the item, and the date and time of purchase, and it can uniquely identify a purchase by the combination of those. The purchase information may contain other information such as a purchase price, a payment method, a delivery method, an evaluation score (for example, evaluation in five levels) assigned to a purchased item by a user (purchaser). In the case where the purchase information contains an evaluation score, the purchase information can be regarded as evaluation information, and the purchase database 23 can be regarded as an evaluation database.

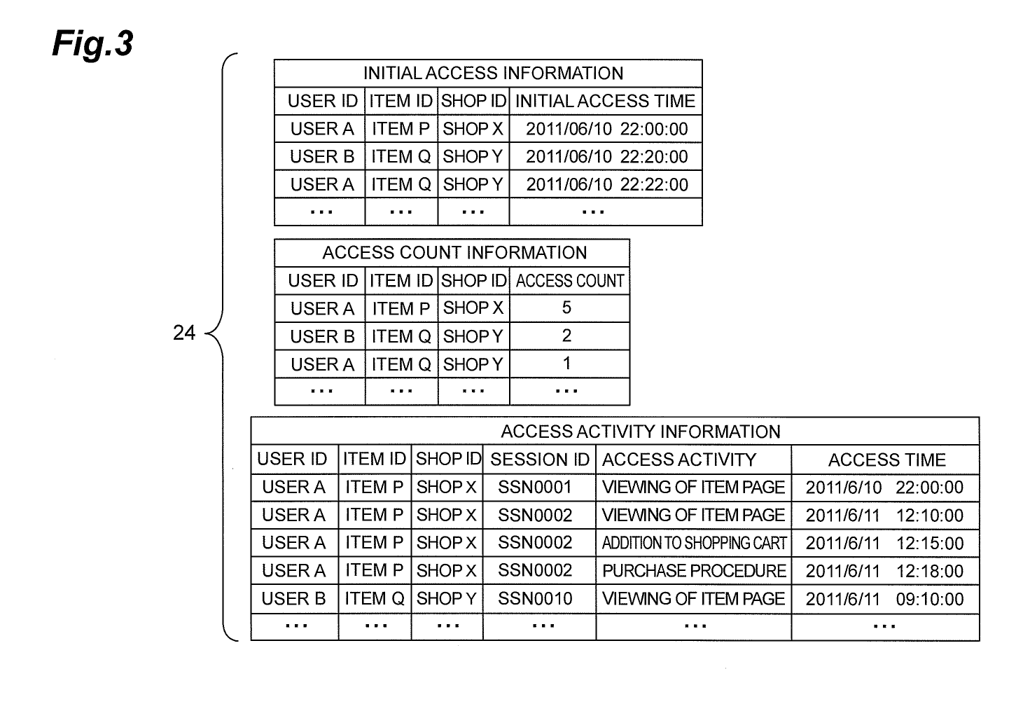

The access history database (storage unit) 24 is a means of storing a user's access activity to item information of an item sold at a shop as an access history. As shown in FIG. 3, the access history database 24 stores initial access information, access count information, and access activity information as an access history. Those information are recorded by an access monitoring unit 12a, which is described later. The access activity information where the access activity is “viewing of item page” in FIG. 3 can be regarded as viewing information indicating that item information has been presented to a viewer. Accordingly, the access history database 24 can be regarded as a viewing database.

The initial access information is data indicating the time (in this embodiment, the day, hour, and minute of the first access) when one user has accessed specific item information for the first time. As shown in FIG. 3(a), in the initial access information, a user ID, an item ID indicated by item information, a shop ID indicating a shop selling the item, and initial access time are associated with one another. The initial access time is the time when a user has accessed specific item information for the first time through a certain web page (for example, an item page or a search result page). Only one record of the initial access information is created for one combination of a user, an item and a shop.

The access count information is data indicating the number of times where one user has accessed specific item information. As shown in FIG. 3(b), in the access count information, a user ID, an item ID indicated by item information, a shop ID indicating a shop selling the item, and an access count are associated with one another. Only one record of the access count information is created for one combination of a user, an item and a shop, and, each time a user accesses the same item at the same shop, the corresponding access count is incremented by one.

The access activity information is data indicating a specified operation performed by one user for specific item information, and it is created each time the operation is made. As shown in FIG. 3(c), in the access activity information, a user ID, an item ID indicated by item information, a shop ID indicating a shop selling the item, a session ID, a specified access activity, and access time (in this embodiment, the day, hour, and minute of access) are associated with one another. The session ID is a value for identifying a session indicating a series of communications during one-time stay in the EC site.

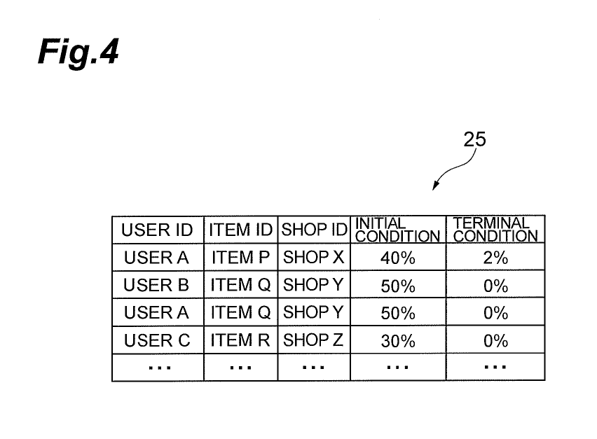

The discount rate database 25 is a means of storing discount rate information indicating a discount rate of a specific item (i.e. a target item) at a specific shop applied to one user. As shown in FIG. 4, in the discount rate information, a user ID, an item ID, a shop ID, an initial condition (first selling condition), and a terminal condition are associated with one another. The initial condition is the discount rate that is presented when a user accesses item information for the first time. The terminal condition is the worst discount rate for a user, which can be reached in the end. Thus, the discount rate does not fall below the value indicated by the terminal condition.

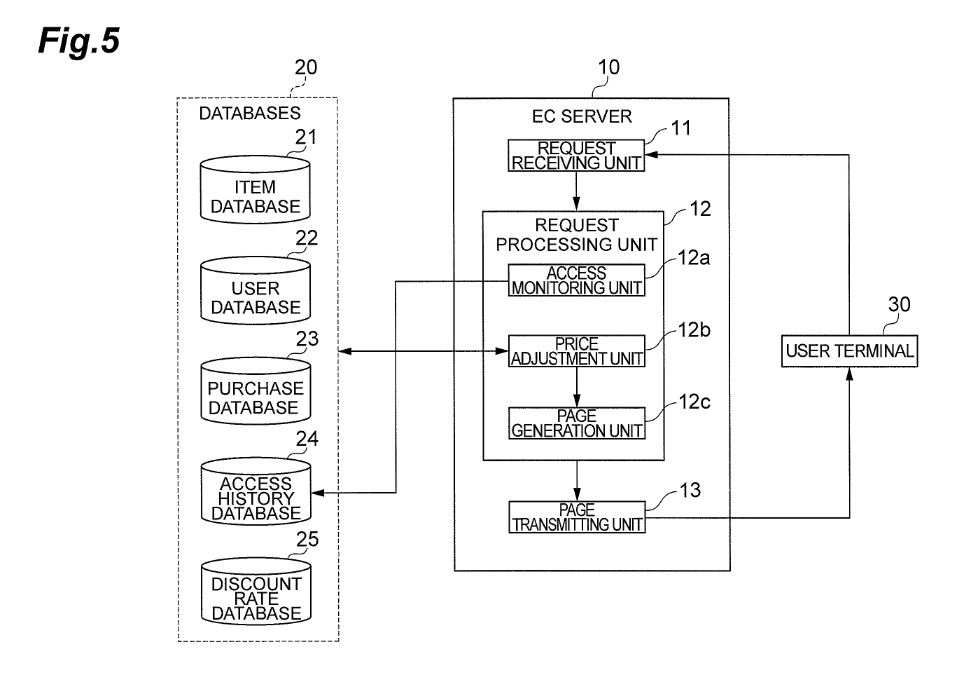

The functions of the EC server 10 are described hereinbelow. As shown in FIG. 5, the EC server 10 is composed of functional elements: a request receiving unit 11, a request processing unit 12, and a page transmitting unit (presentation unit) 13. General functions by those elements are described first.

The request receiving unit 11 is a means of receiving a HTTP (Hypertext Transfer Protocol) request related to the EC site from the user terminal 30. The HTTP request is a request signal for causing the EC server 10 to execute specified processing and obtaining its result. The HTTP request contains information of HTTP Cookie for specifying the state of screen transition and a user, a parameter or data for causing the EC server 10 to execute processing in response to a user operation and the like. The HTTP request is generated in the user terminal 30 and transmitted to the EC server 10 each time a user performs a specified operation on the EC site through the browser on the user terminal 30.

Examples of the specified operation on the EC site include access to a web page (for example, a top page, an item page etc.) of the EC site, search for an item in the EC site, addition of an item to a shopping cart, a payment procedure and the like. However, the type of a user operation to access the EC site is not limited thereto. The request receiving unit 11 outputs the received HTTP request to the request processing unit 12.

The request processing unit 12 is a means of performing various kinds of processing related to the EC site based on the input HTTP request. The request processing unit 12 executes a specified search, operation, data update and the like based on the HTTP request, and further generates a web page to be displayed next on the browser of the user terminal 30 and outputs it to the page transmitting unit 13.

For example, the request processing unit 12 generates a web page indicated by URL (Uniform Resource Locator) specified by the HTTP request. Examples of the web page corresponding to the designated URL include a web page (item page) for displaying information of a target item.

Further, the request processing unit 12 extracts item information that satisfies a search condition for the item specified by the HTTP request from the item database 21 and generates a web page (search result page) for displaying the item information.

Furthermore, the request processing unit 12 performs an item purchase procedure in response to the HTTP request and generates a web page corresponding to the procedural steps. When an operation to add an item to a shopping cart is performed on the browser of the user terminal 30, the request processing unit 12 performs processing of adding the item to the shopping cart of a user based on the HTTP request corresponding to the operation. Then, the request processing unit 12 generates a web page (shopping cart page) for showing the latest state of the shopping cart. Addition of an item to a shopping cart is one activity of the operation that a user selects an item as a candidate to be purchased.

When an operation to proceed with a purchase procedure is performed on the shopping cart page, the request processing unit 12 generates a web page (order page) that prompts a user to select a delivery method and a payment method based on the HTTP request corresponding to that operation. When an operation to confirm the purchase procedure is performed on the order page, the request processing unit 12 performs processing to confirm the purchase of the item based on the HTTP request corresponding to that operation. The purchase confirmation process includes registration of purchase information into the purchase database 23, payment processing, delivery instruction processing and the like.

The page transmitting unit 13 is a means of transmitting the web page input from the request processing unit 12 to the user terminal 30 that has transmitted the HTTP request. The transmitted web page is the HTTP response corresponding to the HTTP request.

Hereinafter, adjustment of a discount rate in this embodiment is described. To implement the adjustment process, the request processing unit 12 includes an access monitoring unit 12a, a price adjustment unit 12b, and a page generation unit 12c (see FIG. 5).

The access monitoring unit (recording unit) 12a is a means of monitoring a user's access activity to item information of an item (target item) sold at a shop and recording the monitoring result as an access history into the access history database 24. The access activity is a concept that includes the presence or absence of access to item information and various operations (for example, viewing, addition to a shopping cart, purchase procedure etc.) performed by a user for the item information.

First, the access monitoring unit 12a analyzes the HTTP request received by the request receiving unit 11 and specifies a combination of a user, an item and a shop and further specifies the current access activity. For example, when the HTTP request indicates a request for a specific item page, the access monitoring unit 12a determines that the current access activity is viewing of an item page. Further, when the HTTP request indicates addition of a specific item to a shopping cart, the access monitoring unit 12a determines that the current access activity is addition to a shopping cart. Furthermore, when the HTTP request indicates confirmation of purchase of a specific item, the access monitoring unit 12a determines that the current access activity is a purchase procedure.

Next, the access monitoring unit 12a determines whether the initial access information corresponding to the combination of the user, the item and the shop specified by the HTTP request exists in the access history database 24 or not. Only when such initial access information does not exist, the access monitoring unit 12a generates the initial access information corresponding to that HTTP request and stores it into the access history database 24. At this time, the access monitoring unit 12a may set the current time as the initial access time. The set initial access time is used as a reference time in the price adjustment unit 12b, which is described later.

Then, the access monitoring unit 12a determines whether the access count information corresponding to the combination of the user, the item and the shop specified by the HTTP request exists in the access history database 24 or not. When such access count information does not exist, the access monitoring unit 12a generates the access count information corresponding to that HTTP request and stores it into the access history database 24. At this time, the access monitoring unit 12a sets the access count to “1”. On the other hand, when the corresponding access count information exists, the access monitoring unit 12a increments the access count in the access count information by one.

Then, the access monitoring unit 12a generates access activity information by associating the combination of the user, the item and the shop specified by the HTTP request, the session ID extracted from the HTTP request, the specified current access activity and the current time with one another. Then, the access monitoring unit 12a stores the generated access activity information into the access history database 24.

The price adjustment unit 12b is a means of adjusting (setting) the discount rate and the price of a target item to be displayed on the web page that is generated as a response to the HTTP request. As a user puts off a decision to purchase a target item, the price adjustment unit 12b lowers the discount rate of the item presented to the user. As a result, the price of the item becomes higher.

The price adjustment unit 12b adjusts the discount rate and the price to be presented to a user this time using the access history and the discount rate information corresponding to the combination of the user, the item and the shop specified by the HTTP request. The price adjustment unit 12b refers to the item information, the user information or the purchase information corresponding to the user, the item or the shop specified by the HTTP request according to need. Several methods of changing a discount rate are described below.

### Adjustment Depending on the Lapse of Time

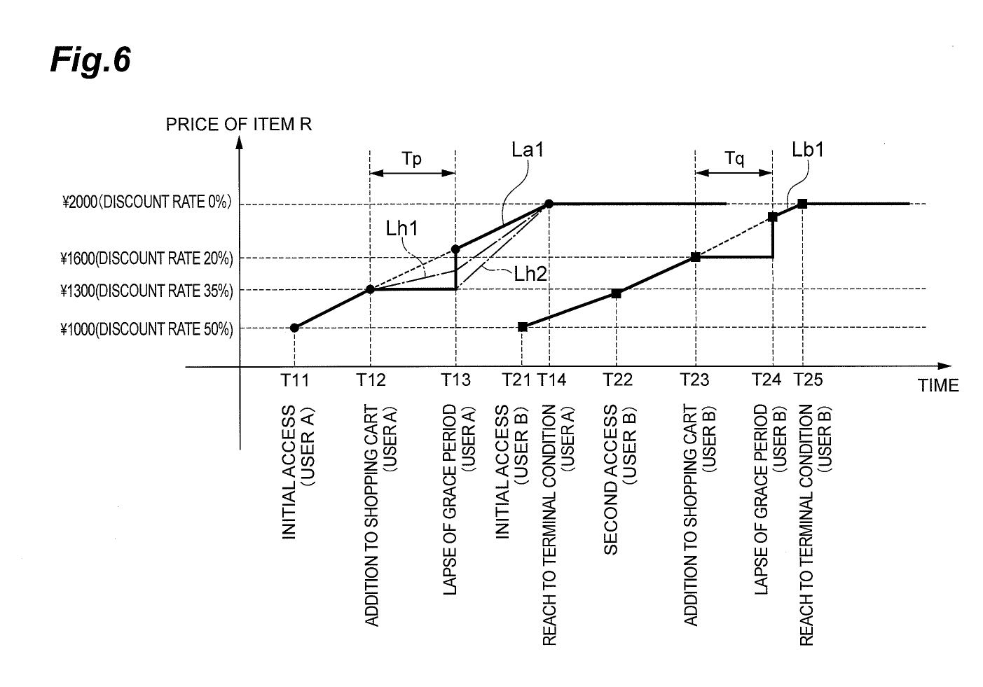

The price adjustment unit 12b may adjust the discount rate of a target item to be applied to a user depending on the elapsed time from the time when the user has recognized the target item for the first time. This adjustment method is described with reference to FIG. 6.

FIG. 6 shows the variation of the discount rate and the price of an item R which are applied to each of users A and B. In the example of FIG. 6, the initial condition and the terminal condition for each user on the discount rate of the item R whose regular price is 2,000 yen are 50% and 0%, respectively. The solid line La1 shows one example of the variation of the discount rate and the price which are applied to the user A, and the solid line Lb1 shows one example of the variation of the discount rate and the price which are applied to the user B. At the time T11 to T14 and T21 to T25 in FIG. 6, the following events occur. Time T11 is a reference time for the user A, and time T21 is a reference time for the user B. The price adjustment unit 12b specifies the events as shown in FIG. 6 based on the access history of each user.

Time T11 . . . The user A accessed the item page of the item R for the first time.

Time T12 . . . The user A added the item R to the shopping cart.

Time T13 . . . Time Tp elapsed from when the user A added the item R to the shopping cart.

Time T14 . . . The discount rate of the item R applied to the user A reached the terminal condition.

Time T21 . . . The user B accessed the item page of the item R for the first time.

Time T22 . . . The user B accessed the item page of the item R for the second time.

Time T23 . . . The user B added the item R to the shopping cart.

Time T24 . . . Time Tq elapsed from when the user B added the item R to the shopping cart.

Time T25 . . . The discount rate of the item R applied to the user B reached the terminal condition.

Starting from when the user A makes the first access to the item page as a trigger, the price adjustment unit 12b lowers the discount rate of the item R which is applied to the user A with the lapse of time from 50% at a specified rate of change (second rate of change) (time T11 to T12). The rate of change in this embodiment is a value indicating the amount of a decrease in the discount rate per unit time, and it is, stated exactly, the rate of change in the discount rate per unit time.

During the period until a specified grace period Tp elapses from when the user A adds the item R to the shopping cart (time T12 to T13), the price adjustment unit 12b temporarily fixes the discount rate. This fixation means setting the rate of change (first rate of change) to 0. In the example of FIG. 6, the discount rate that is applied to the user A is temporarily fixed to 35%, and, in the case where the user A purchases the item R during the grace period Tp, it is only necessary to pay 1,300 yen. On the other hand, in the case where the user A does not purchase the item R during the grace period Tp, the price adjustment unit 12b changes the discount rate at time T13, which is at the end of the grace period Tp, to the same value as when there is no grace period and then lowers the discount rate at a specified rate of change (second rate of change) after that (time T13 to T14). The discount rate and the price after time T14 do not change.

The price adjustment unit 12b adjusts the discount rate of the item R that is applied to the user B in the same manner as the case of the user A. Starting from when the user B makes the first access to the item page as a trigger, the price adjustment unit 12b lowers the discount rate of the item R which is applied to the user B with the lapse of time from 50% at a specified rate of change (second rate of change) (time T21 to T22). In the example of FIG. 6, because the user B does not purchase the item R at the initial access, the price adjustment unit 12b lowers the discount rate at a specified rate of change (second rate of change) continuously when the user B makes the second access after that (time T22 to T23).

During the period until a specified grace period Tq elapses from when the user B adds the item R to the shopping cart (time T23 to T24), the price adjustment unit 12b temporarily fixes the discount rate (first rate of change). In the example of FIG. 6, the discount rate that is applied to the user B is temporarily fixed to 20%, and, in the case where the user B purchases the item R during the grace period Tq, it is only necessary to pay 1,600 yen. On the other hand, in the case where the user B does not purchase the item R during the grace period Tq, the price adjustment unit 12b changes the discount rate at time T24, which is at the end of the grace period Tq, to the same value as when there is no grace period and then lowers the discount rate at a specified rate of change (second rate of change) after that (time T24 to T25). The discount rate and the price after time T25 do not change.

In this manner, for a user, the longer the time passes from the first access (reference time), the less favorable the discount rate applied to him/herself becomes.

The adjustment method when an item is added to a shopping cart is not limited to those indicated by the solid lines La1 and Lb1 in FIG. 6. For example, the price adjustment unit 12b may set the rate of change during the grace period lower than that during a period other than the grace period and then set the rate of change after the grace period larger again as indicated by the alternate long and short dashed line Lh1 in FIG. 6, instead of temporarily fixing the discount rate. Alternatively, the price adjustment unit 12b may temporarily fix the discount rate as described above and then change the rate of change to a larger value than before the fixation from the time at the end of the grace period, or change the rate of change back to the value before the grace period as indicated by the alternate long and short dashed line Lh2 in FIG. 6.

In any way, because an item added to a shopping cart is likely to be purchased, there is less need to make a further change to the selling condition of the item. On the other hand, if the discount rate and the price of an item selected to be purchased by a user change more than necessary, there is a possibility that the user decides not to purchase it. Accordingly, by reducing the rate of change in the discount rate of the item added to the shopping cart, it is possible to prompt a user to purchase the item.

Note that the rate of change may vary in a given period other than the grace period described above. For example, the rate of change during a period from the m-th access to the (m+1)th access to the EC site and the item page of a target item may be set higher than or lower than the rate of change during one session.

### Adjustment Depending on the Number of Accesses

The price adjustment unit 12b may adjust the discount rate of a target item to be applied to a user depending on the number of accesses from the time when the user has recognized the target item for the first time. In this case, the discount rate does not vary during one session corresponding to one-time access, and the discount rate decreases when a user accesses the EC site again and accesses the same item page after the user once left that site.

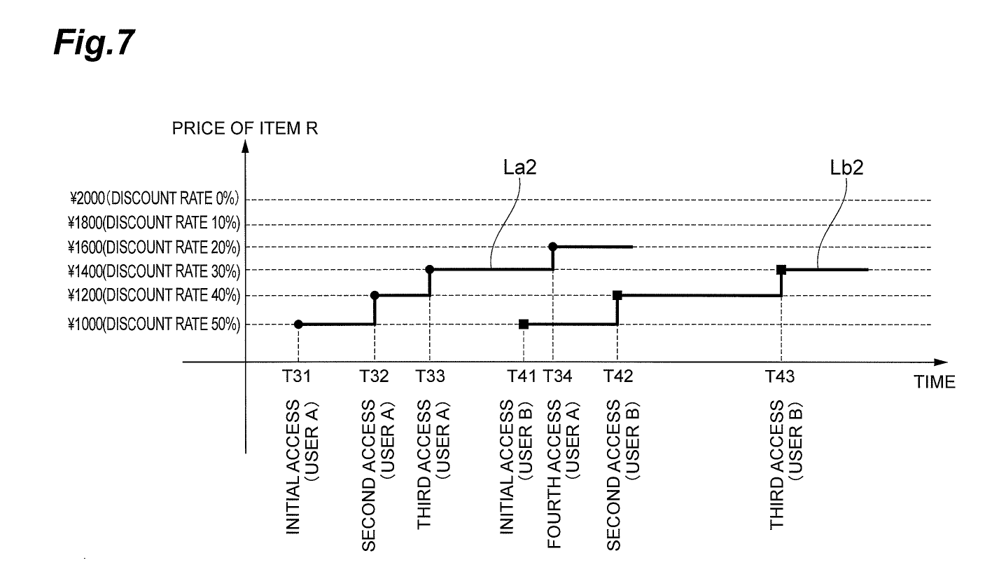

This adjustment method is described with reference to FIG. 7. FIG. 7 shows the variation of the discount rate and the price of an item R which are applied to each of users A and B. In the example of FIG. 7 also, it is assumed that the regular price of the item R is 2,000 yen, and the initial condition and the terminal condition for each user are 50% and 0%, respectively. The solid line La2 shows one example of the variation of the discount rate and the price which are applied to the user A, and the solid line Lb2 shows one example of the variation of the discount rate and the price which are applied to the user B. Time T31 to T34 and T41 to T43 in FIG. 7 indicate the time when a user starts accessing the item page. Time T31 is a reference time for the user A, and time T41 is a reference time for the user B. The price adjustment unit 12b specifies the access activity of each user as shown in FIG. 7 from the access history of each user.

When the user A accesses the page of the item R for the first time (time T31), the price adjustment unit 12b sets the discount rate of the item R which is applied to the user A to 50%. In the case where the user A purchases the item R during one session at the first access, it is only necessary to pay 1,000 yen. On the other hand, in the case where the user A lefts the EC site without purchasing the item R, the user A loses an opportunity for purchasing the item R for 1,000 yen and, when the user accesses the page of the item R next time (time T32), the user can obtain the discount rate of only 40%. Further, in the case where the user A purchases the item R during one session at the second access, it is only necessary to pay 1,200 yen; on the other hand, in the case where the user A lefts the EC site without purchasing the item R, the discount rate further decreases at the time of next access (see time T33 and T34). The price adjustment unit 12b adjusts the discount rate for the user A in the same manner after time T34 as well. Further, the price adjustment unit 12b adjusts the discount rate for the user B in the same manner as for the user A (see time T41 and T43).

Therefore, for a user, the larger the number of visits to the EC site and an item page, the less favorable the discount rate applied to him/herself becomes. Note that the price adjustment unit 12b does not necessarily adjust the discount rate each time the number of accesses increases by one. For example, the price adjustment unit 12b may lower the discount rate that has been set at the first access for the first time at the fourth access.

### Setting of the Rate of Change in Discount Rate Per Unit Time

The price adjustment unit 12b may change the rate of change dynamically when adjusting the discount rate depending on the lapse of time as shown in FIG. 6. Several examples are described below.

The price adjustment unit 12b may count the number of sales of a target item during a specified period of time based on the purchase information and increase the rate of change in accordance with an increase in that number. For example, the price adjustment unit 12b sets the rate of change to Hr1 when the number of sales during the most recent month is less than 100, sets the rate of change to Hr2 when the number of sales is 100 to less than 500, and sets the rate of change to Hr3 when the number of sales is 500 or more (where Hr1<Hr2<Hr3).

Alternatively, the price adjustment unit 12b may calculate the statistics (for example, an average value or a median value) of users' evaluation scores on a target item based on the purchase information and increase the rate of change in accordance with an increase in the statistics. For example, the price adjustment unit 12b sets the rate of change to Hr1 when the statistics value is less than 3 and sets the rate of change to Hr2 when the statistics value is 3 or more (where Hr1<Hr2).

Because an item with a large number of sales (high frequency of order) or with a high evaluation score is more likely to be purchased by a user, setting the rate of change in consideration of the number of sales and the evaluation score is effective to encourage the purchase of such an item. Note that, however, when there is an opposite tendency, the price adjustment unit 12b may set a smaller rate of change in accordance with an increase in the number of sales or the evaluation score.

The price adjustment unit 12b may determine the type of the user terminal 30 and set different rates of change for a user using a terminal capable of displaying a plurality of web pages at the same time (for example, a personal computer) and a user using a terminal capable of displaying only one web page at a time (for example, a mobile phone). In this case, the EC server 10 acquires the HTTP request containing terminal information indicating the type of a terminal, and the price adjustment unit 12b determines the type of a terminal based on the terminal information. The terminal information is written in the User-Agent header of the HTTP request, for example.

For example, the price adjustment unit 12b makes the discount rate for a terminal capable of displaying a plurality of web pages at the same time lower than the discount rate for a terminal capable of displaying only one web page at a time. Alternatively, the price adjustment unit 12b may lower the discount rate step by step in accordance with an increase in the number of web pages that can be displayed at the same time. There is a tendency that a user promptly decides the purchase in the environment where it is difficult to view a plurality of sites (such as other EC sites and a price comparison site) at the same time, and it is possible to use this technique to encourage such a tendency. Note that, however, when there is an opposite tendency, the price adjustment unit 12b may make the discount rate for a terminal capable of displaying a plurality of web pages at the same time larger than the discount rate for a terminal capable of displaying only one web page at a time.

The price adjustment unit 12b may calculate the statistics (for example, an average value or a median value) of time for a user to purchase a target item after the item information of the target item is presented to the user based on the access history and the purchase information and decreases the rate of change in accordance with an increase in the statistics. For example, the price adjustment unit 12b sets the rate of change to Hr1 when the statistics value is less than 30 minutes and sets the rate of change to Hr2 when the statistics value is 30 minutes or more (where Hr1>Hr2). Such processing intends to set a higher rate of change for a user who is likely to make impulse buying, and it is an advantageous method to encourage impulse buying. Note that, however, the price adjustment unit 12b may set a higher rate of change as the calculated statistics value is larger in order to encourage the purchase of users who do not make impulse buying.

A method of calculating the statistics is not limited thereto. For example, in the case where time of opening email (for example, e-mail newsletter) to recommend an item can be acquired, the price adjustment unit 12b may calculate the statistics of time to purchase the item from the email open time, using the email open time as the time when the item information is presented.

The price adjustment unit 12b may lower the rate of change in accordance with a decrease in the quantity of stock of a target item that is acquired by referring to the item information. For example, the price adjustment unit 12b sets the rate of change to Hr1 when the acquired quantity of stock is 50 or more and sets the rate of change to Hr2 when the quantity of stock is less than 50 (where Hr1>Hr2). Because promoting the purchase of an item with a small quantity of stock causes out-of-stock, it is effective to set the rate of change in order to avoid out-of-stock.

The price adjustment unit 12b may calculate the number of users who are provided with adjustment of the discount rate for a target item by summarizing the access histories of the target item and lower the rate of change in accordance with an increase in the number of users. The users who are provided with adjustment of the discount rate for a target item are users who have not yet purchased the item after accessing the page of the item and for whom the discount rate for the item has not yet reached the terminal condition. For example, the price adjustment unit 12b sets the rate of change to Hr1 when the calculated number of users is less than the quantity of stock of the target item and sets the rate of change to Hr2 when the number of users is the quantity of stock or more (where Hr1>Hr2). Because promoting the purchase of an item to which a certain number or more of users are accessing causes out-of-stock, it is effective to lower the rate of change in order to avoid out-of-stock. Note that the value to be compared with the number of users by the price adjustment unit 12b is not limited to the quantity of stock. For example, it may be a fixed value such as 100 or a reference value based on the quantity of stock (for example, 80% of the quantity of stock).

### Setting of the Rate of Change Based on Time to Next Access

When adjusting the discount rate depending on the number of accesses, the price adjustment unit 12b may dynamically set the rate of change from the discount rate in the previous access to the discount rate in the current access. Specifically, the price adjustment unit 12b may increase the rate of change in the current access in accordance with an increase in the time interval (access interval) from the end of the previous access to the start of the current access. For example, the price adjustment unit 12b sets the rate of change to Hr1 when the access interval is less than 24 hours, sets the rate of change to Hr2 when the access interval is 24 hours to less than 72 hours, and sets the rate of change to Hr3 when the access interval is 72 hours or more (where Hr1<Hr2<Hr3).

Note that, in the case of setting the rate of change dynamically as described above, the number of rates of change that can be applied may be set arbitrarily. For example, two levels of rates of change may be prepared, or three or ten levels of rates of change may be prepared. By setting the rate of change in consideration of the access interval, it can be expected that a user will access the EC site and the item page in the nearer future and thus can be expected that a user will purchase the item early.

### Setting of Initial Condition and Terminal Condition

In the case of setting the rate of change depending on the lapse of time for each user, the price adjustment unit 12b may set the initial condition and the terminal condition for the discount rate to be referred to in accordance with the rate of change for each user.

For example, the price adjustment unit 12b may set the initial condition so that it is more favorable for a user with a higher rate of change. For example, in the case where the rates of change for the users A and B are 5% and 3%, respectively, the price adjustment unit 12b may set the initial condition for the user A to 50% and set the initial condition for the user B to 45%. In this manner, by setting the initial condition to a value that is more favorable for a user and increasing the rate of change of the discount rate after that, it is possible to prompt the user to purchase the item early.

Further, the price adjustment unit 12b may change the terminal condition on a target item for a user by referring to an item in the user's shopping cart. Specifically, in the case where the terminal condition on a target item is the same as or similar to that on the item and the price derived from the terminal condition is higher than the price of another item that is placed in the shopping cart by the user, the price adjustment unit 12b sets the final discount rate of the target item to the discount rate corresponding to the current price of the other item. In this manner, by changing the selling condition on the target item in consideration of another item, it is possible to prompt the user to purchase the target item.

As described above, the price adjustment unit 12b can use various methods to set the discount rate for a target item for each user.

In any way, in the case where a user does not purchase a target item after the initial access time (reference time), the price adjustment unit 12b adjusts the discount rate of the target item for the user based on the user's access activity to the item information after the initial access time. Because the discount rate after adjustment (second selling condition) is lower than the discount rate indicated by the initial condition (first selling condition), it is an unfavorable value for the user.

The page generation unit 12c is a means of generating a web page corresponding to the HTTP request. When generating a page that shows a price with a discount rate taken into account such as an item page and a shopping cart page, the page generation unit 12c shows the discount rate and the price input from the price adjustment unit 12b on the page. As a result, the discount rate and the price after adjustment, in place of the discount rate and the price before adjustment, are displayed on the web page. The page generation unit 12c outputs the generated web page to the page transmitting unit 13.

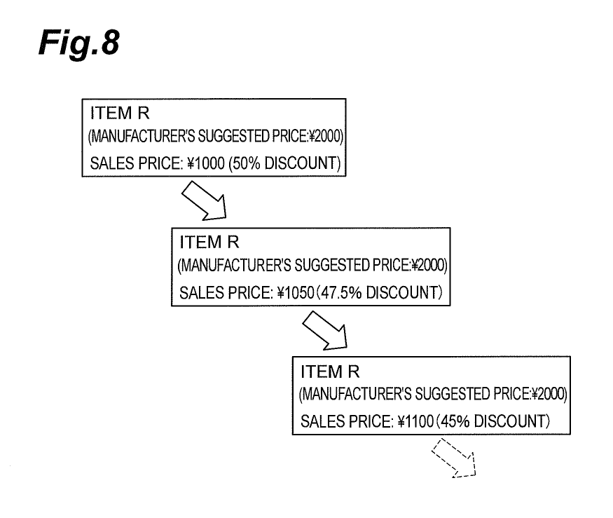

In the case where the discount rate is adjusted depending on the lapse of time, the page generation unit 12c may embed a program that varies the discount rate and the price on a web page into the web page. In the case of using this program, information of the target item is displayed so that the discount rate of the item decreases little by little and the price increases little by little as shown in FIG. 8.

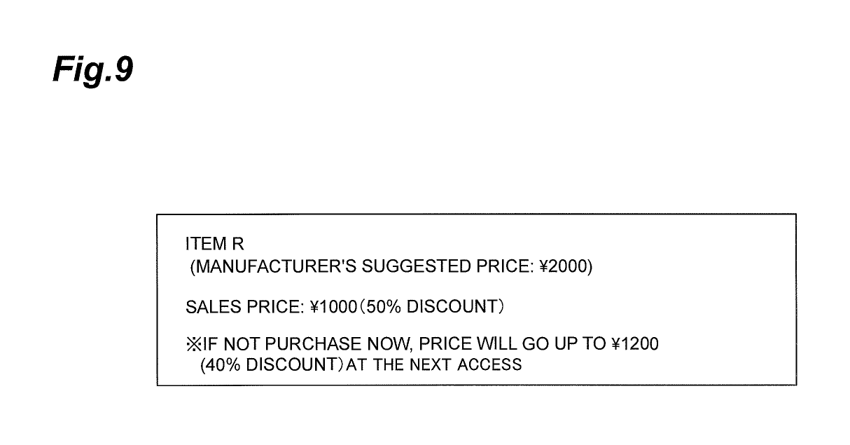

In the case where the discount rate is adjusted depending on the number of accesses, the page generation unit 12c may display not only the discount rate and the price for the current time but also an advance notice message indicating that the discount rate for the next time (next condition) will be lower than the current rate on a web page. The discount rate for the next time can be obtained by the processing of the price adjustment unit 12b described above. For example, the page generation unit 12c adds the advance notice message “If not purchase now, price will go up to ¥1200 (40% discount) at the next access” as shown in FIG. 9 to the web page. In the case where the rate of change of the discount rate is adjusted dynamically based on the access interval, the price adjustment unit 12b may predict the next access time based on a user's access history for a target item and calculate the discount rate and the price using the rate of change corresponding to the next access time. Note that, instead of displaying such an advance notice message on a web page, the advance notice message may be transmitted to a user through email, email newsletter or the like by a specified email function.

The web page generated in the above manner is transmitted to the user terminal 30 by the page transmitting unit 13, and thereby a user can know the discount rate and the price of an item which the user is about to view or is currently viewing. In the case where the advance notice message is displayed, the user can know the future discount rate and price which are less favorable than the current ones. In this manner, by letting a user know the selling condition on a target item, it is possible to prompt the user to purchase the item.

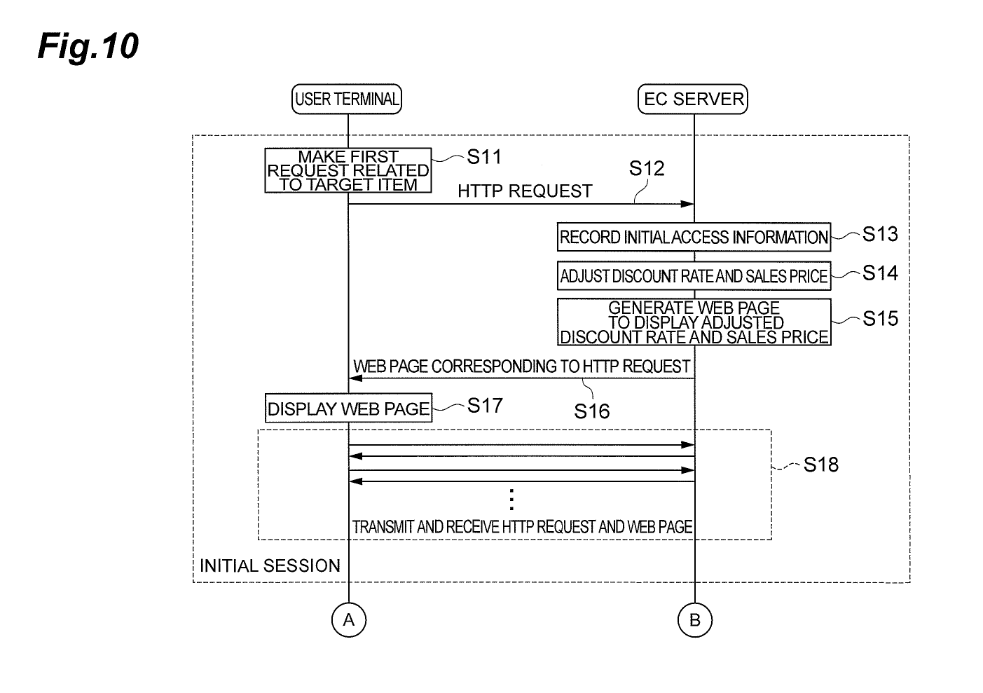

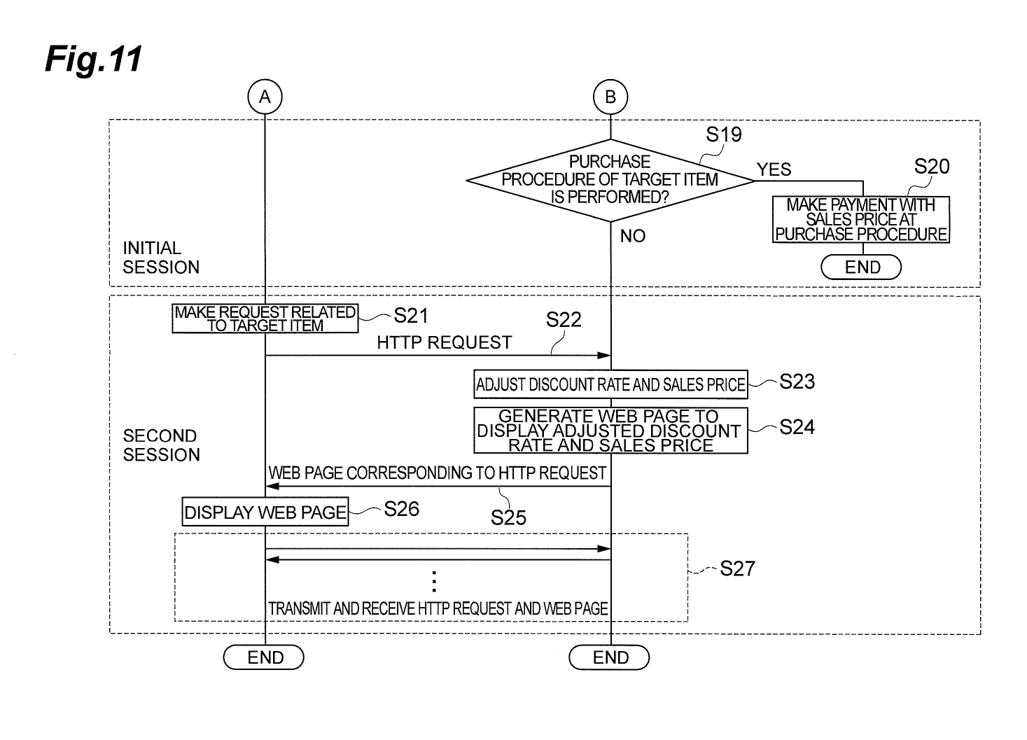

The operation of the EC system 1 is described and further an electronic commerce method according to this embodiment is described hereinafter with reference to FIGS. 10 and 11.

In the case where the first request related to a target item is executed in the user terminal 30 (for example, in the case of requesting an item page of a target item for the first time) (Step S11), the HTTP request indicating the request is transmitted from the user terminal 30 to the EC server 10 (Step S12). The first session for the target item thereby starts.

In the EC server 10, the request receiving unit 11 receives the HTTP request, and the request processing unit 12 performs the processing in response to the request. The received HTTP request is a signal for accessing the item information of the target item for the first time, and therefore the access monitoring unit 12a generates the initial access information based on the request and stores it into the access history database 24 (Step S13, recording step). Further, the access monitoring unit 12a stores the access count information and the access activity information into the access history database 24. Then, the price adjustment unit 12b adjusts the discount rate and the price of the target item by using any one of the above-described techniques (Step S14, adjustment step). After that, the page generation unit 12c generates a web page that displays the adjusted discount rate and price (Step S15), and the page transmitting unit 13 transmits the web page to the user terminal 30 (Step S16, presentation step). The web page that shows the item information of the target item is thereby displayed on the user terminal 30 (Step S17).

After that, the transmission and reception of the HTTP request and the transmission and reception of the web page in response to the request are performed between the user terminal 30 and the EC server 10 (Step S18). For example, addition of the target item to a shopping cart, request for an order page and the like are included in the processing of Step S18. Each time receiving a request, the access monitoring unit 12a analyzes the received HTTP request and generates the access activity information, and stores the access activity information into the access history database 24.

In the case where a procedure to purchase the target item is performed in the processing in Step S18 (YES in Step S19), payment processing with the price at the time of the procedure is executed by the request processing unit 12 (Step S20).

On the other hand, in the case there the first session ends without purchase of the target item (NO in Step S19) and, after that, the user accesses the EC site again and makes a request for the item information of the target item again (Step S21), the HTTP request indicating the request is transmitted from the user terminal 30 to the EC server 10 (Step S22). The second session for the target item thereby starts.

In the EC server 10, the request receiving unit 11 receives the HTTP request, and the request processing unit 12 performs the processing in response to the request. Because the HTTP request does not indicate the first access to the item information of the target item, the initial access information is not generated. In the request processing unit 12, the access monitoring unit 12a stores the access count information and the access activity information into the access history database 24. Further, the price adjustment unit 12b adjusts (re-adjusts) the discount rate and the price of the target item by using any one of the above-described techniques (Step S23, adjustment step). After that, the page generation unit 12c generates a web page that displays the adjusted discount rate and price (Step S24), and the page transmitting unit 13 transmits the web page to the user terminal 30 (Step S25, presentation step). The web page that shows the item information of the target item is thereby displayed on the user terminal 30 (Step S26). The discount rate that is presented in this step is lower than the discount rate that is presented in the above-described step S17, and therefore the price is higher than that at the time of the previous access.

After that, the transmission and reception of the HTTP request and the transmission and reception of the web page in response to the request are performed between the user terminal 30 and the EC server 10 (Step S27). Each time receiving a request, the access monitoring unit 12a analyzes the received HTTP request and generates the access activity information, and stores the access activity information into the access history database 24. The processing after Step S27 is the same as the processing after Step S18 described above. Further, in the case there the second session ends without purchase of the target item and then the user accesses the EC site again and makes a request for the item information of the target item again, the processing in the third session is performed in the same manner as the processing in the second session.

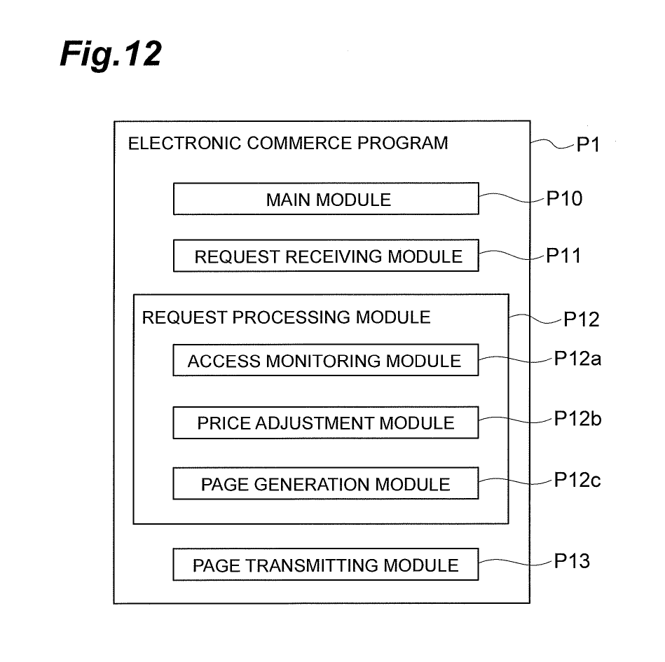

An electronic commerce program P1 that causes a computer to function as the EC server 10 is described hereinafter with reference to FIG. 12.

The electronic commerce program P1 includes a main module P10, a request receiving module P11, a request processing module P12, and a page transmitting module P13. The request processing module P12 includes an access monitoring module P12a, a price adjustment module P12b, and a page generation module P12c.

The main module P10 is a part that exercises control over the electronic commerce functions. The functions implemented by the request receiving module P11, the request processing module P12 and the page transmitting module P13 are respectively the same as the functions of the request receiving unit 11, the request processing unit 12 and the page transmitting unit 13. The functions implemented by the access monitoring module P12a, the price adjustment module P12b and the page generation module P12c are respectively the same as the functions of the access monitoring unit 12a, the price adjustment unit 12b and the page generation unit 12c.

The electronic commerce program P1 is provided in the form of being recorded in a static manner on a recording medium such as CD-ROM, DVD-ROM or semiconductor memory, for example. Further, the electronic commerce program P1 may be provided as a data signal superimposed onto a carrier wave through a communication network.

As described above, according to this embodiment, if a user does not purchase an item (target item) indicated by item information after the time when the user accesses the item information for the first time, the discount rate of the item is adjusted to become lower, and the discount rate that is lower than before (and the price that is higher than before) is presented to the user. Accordingly, as the decision of purchase is earlier, the purchase condition applied to the user is more favorable, and therefore early purchase is encouraged to each user. As a result, it is possible to promote the purchase of an item in electronic commerce more effectively.

In any of adjustment depending on the lapse of time and adjustment depending on the number of accesses, the same effect can be expected. In the case of making adjustments depending on the lapse of time, user's purchase can be encouraged in one session. In this case, by presenting the way the discount rate falls (the way the price rises) with the lapse of time to a user in real time, it is possible to more effectively promote the purchase of an item by the user.

On the other hand, in the case of making adjustments depending on the number of accesses, because the discount rate is fixed during one session, a user can take time to make a decision on purchase during one session. In this case, by presenting a message indicating that the discount rate will fall (the price will rise) at the time of next access to a user, it is possible to more effectively promote the purchase of an item by the user.

Hereinbefore, the present invention has been described in detail with respect to the embodiment thereof. However, the present invention is not limited to the above-described embodiment. Various changes and modifications may be made therein without departing from the scope of the invention.

Although the selling condition that is adjusted by the price adjustment unit 12b is the discount rate in the above-described embodiment, the adjustment unit may adjust another selling condition. For example, the adjustment unit may adjust the rate for granting points that serves as a basis for calculating points granted to a user at the purchase of an item, or the actual price of an item that is displayed on a search result page. In the case of adjusting the rate for granting points, when a user does not purchase a target item after the initial access time, the adjustment unit lowers the rate for granting points at the purchase of the item little by little. In the case of adjusting the actual price, when a user does not purchase a target item after the initial access time, the adjustment unit raises the price of the item little by little. Further, the adjustment unit may adjust the cost for a sales promotion gift (extra bonus) that is awarded to a user (orderer) for the order of an item or a service. In the case of adjusting the cost for a sales promotion gift, when a user does not purchase a target item after the initial access time, the adjustment unit lowers the value of the sales promotion gift little by little.

Further, the adjustment unit may reduce the volume or the number of items at one sales little by little or change the service level.

An example of changing the service level is gradually reducing the rank of a guest room of a hotel. In the case where the service level is selected as the selling condition to be adjusted, there can be a case where the selling condition cannot be represented by numerical values.

Although the time when a user has accessed the item information of a target item for the first time is used as a reference time in the above-described embodiment, the reference time may be set to another time point. For example, using the time when a user has accessed the item information of a target item for the third time as a reference time, the selling condition after that may be adjusted. In this case, the selling condition at the time when the third access is made is the initial condition (first selling condition). Further, in the case where the time of opening email (for example, e-mail newsletter) to recommend an item and a user ID can be acquired, using the time of opening as a reference time, the selling condition after that may be adjusted. In this case, the selling condition at the time when an e-mail is opened is the initial condition (first selling condition) corresponding to the user ID.

Although one aspect of the present invention is applied to a virtual shopping mall in the above-described embodiment, the present invention may be applied to an online shopping system of one shop. In this case, there is no need to include a shop ID in the access history and the discount rate information because it is not necessary to distinguish between shops.

### REFERENCE SIGNS LIST

1 . . . EC system, 10 . . . EC server, 11 . . . request receiving unit, 12 . . . request processing unit, 12a . . . access monitoring unit, 12b . . . price adjustment unit, 12c . . . page generation unit, 13 . . . page transmitting unit, 21 . . . item database, 22 . . . user database, 23 . . . purchase database, 24 . . . access history database, 25 . . . discount rate database, 30 . . . user terminal, P1 . . . electronic commerce program, P10 . . . main module, P11 . . . request receiving module, P12 . . . request processing module, P12a . . . access monitoring module, P12b . . . price adjustment module, P12c . . . page generation module, P13 . . . page transmitting module

1. An electronic commerce device comprising:
a recording unit configured to record time when a user has accessed item information indicating an item sold with a first selling condition as a reference time into a storage unit;
an adjustment unit configured to, when the user accesses the item information after the reference time, set a second selling condition being less favorable to the user than the first selling condition based on an elapsed time period from the reference time to the access or the number of accesses to the item information by the user after the reference time; and
a presentation unit configured to present the second selling condition in place of the first selling condition to the user.

2. The electronic commerce device according to claim 1, wherein
the recording unit further records access activity to the item information by the user after the reference time into the storage unit, and
the adjustment unit sets the second selling condition based further on the access activity.

3. The electronic commerce device according to claim 1, wherein
the selling condition is represented by a numerical value, and
the adjustment unit sets the second selling condition depending on elapsed time from the reference time using a rate of change of the selling condition per unit time.

4. The electronic commerce device according to claim 3, wherein
when the item is selected as a candidate to be purchased by the user, the adjustment unit sets a first rate of change during a specified period from when the item is selected as a candidate to be purchased to be lower than a second rate of change during a period other than the specified period.

5. The electronic commerce device according to claim 3, wherein
the adjustment unit refers to a purchase database configured to store purchase information indicating that a purchaser has purchased an item and calculates the number of sales of the item during a specified period, and increases the rate of change in accordance with an increase in the number of sales.

6. The electronic commerce device according to claim 3, wherein
the adjustment unit refers to an evaluation database configured to store evaluation information indicating an evaluation score assigned to a purchased item by a purchaser and calculates statistics of evaluation scores of the item, and increases the rate of change in accordance with an increase in the statistics.

7. The electronic commerce device according to claim 3, wherein
the adjustment unit acquires terminal information indicating a type of a terminal of the user from the terminal, determines the number of web pages that can be displayed at the same time on the terminal based on the terminal information, and reduces the rate of change in accordance with an increase in the number of web pages that can be displayed at the same time.

8. The electronic commerce device according to claim 3, wherein
the adjustment unit refers to a viewing database configured to store viewing information indicating that item information has been presented to a viewer and a purchase database configured to store purchase information indicating that a purchaser has purchased an item and calculates statistics of time for the user to purchase an item indicated by the item information after the item information is presented to the user, and reduces the rate of change in accordance with an increase in the statistics.

9. The electronic commerce device according to claim 7, wherein
the adjustment unit sets the first selling condition to a favorable condition to the user in accordance with an increase in the rate of change applied to the user.

10. The electronic commerce device according to claim 7, wherein
the adjustment unit sets the second selling condition within a range from the first selling condition to a terminal condition being a final selling condition for the item applied to the user, and
when the terminal condition for the item is less favorable to the user than the current selling condition for another item being the same as or similar to the item and selected as a candidate to be purchased by the user, the adjustment unit sets the terminal condition to be the same as the current selling condition for the another item.

11. The electronic commerce device according to claim 3, wherein
the adjustment unit refers to an item database configured to store item information indicating the quantity of stock of items and acquires the quantity of stock of the item, and reduces the rate of change in accordance with a decrease in the quantity of stock.

12. The electronic commerce device according to claim 3, wherein
the adjustment unit refers to a viewing database configured to store viewing information indicating that item information has been presented to a viewer and calculates the number of users who are provided with adjustment of the selling condition for the item, and reduces the rate of change in accordance with an increase in the number of users.

13. The electronic commerce device according to claim 3, wherein
the first and second selling conditions are represented by a price of the item, and
the price corresponding to the second selling condition is higher than the price corresponding to the first selling condition.

14. The electronic commerce device according to claim 1, wherein
when the second selling condition is set based on the number of accesses, the adjustment unit sets the second selling condition corresponding to n-th access in accordance with a time interval from an end of m-th access to a start of the n-th access after the reference time, where m<n.

15. The electronic commerce device according to claim 14, wherein
the adjustment unit obtains the second selling condition for when the user accesses the item information next time as next condition, and
the presentation unit presents the next condition to the user.

16. The electronic commerce device according to claim 14, wherein
the first and second selling conditions are represented by a price of the item, and
the price corresponding to the second selling condition is higher than the price corresponding to the first selling condition.

17. An electronic commerce method executed by an electronic commerce device, the method comprising:
a recording step of recording time when a user has accessed item information indicating an item sold with a first selling condition as a reference time into a storage unit;
an adjustment step of, when the user accesses the item information after the reference time, setting a second selling condition being less favorable to the user than the first selling condition based on an elapsed time period from the reference time to the access or the number of accesses to the item information by the user after the reference time; and
a presentation step of presenting the second selling condition in place of the first selling condition to the user.

18. (canceled)

19. A non-transitory computer-readable recording medium storing an electronic commerce program causing a computer to implement:
a recording unit configured to record time when a user has accessed item information indicating an item sold with a first selling condition as a reference time into a storage unit;
an adjustment unit configured to, when the user accesses the item information after the reference time, set a second selling condition being less favorable to the user than the first selling condition based on an elapsed time period from the reference time to the access or the number of accesses to the item information by the user after the reference time; and
a presentation unit configured to present the second selling condition in place of the first selling condition to the user.
